(19) United States
(12) Patent Application Publication
(10) Pub. No.: US 2026/0084093 A1
(43) Pub. Date: Mar. 26, 2026

(54) Methods for Producing a Fertilizer From a Gas Stream Comprising a Nitrogen-Based Compound

(71) Applicants: Stephen R. Temple, Santa Cruz, CA (US); Bjorn Temple, Santa Cruz, CA (US)

(72) Inventors: Stephen R. Temple, Santa Cruz, CA (US); Bjorn Temple, Santa Cruz, CA (US)

(21) Appl. No.: 19/334,670

(22) Filed: Sep. 19, 2025

Related U.S. Application Data
(60) Provisional application No. 63/697,219, filed on Sep. 20, 2024.

(51) Int. Cl. B01D 53/14; C05C 11/00; C05G 5/20

(52) U.S. Cl. CPC B01D 53/1418; B01D 53/1425; B01D 53/1493; C05C 11/00; C05G 5/20; B01D 2252/20; B01D 2257/40

(57) ABSTRACT

The present invention is directed to methods for treating a gas stream by removing one or more targeted compounds from the gas stream into a liquid scrubbing solution. Such treatment of the gas stream may be performed to produce a liquid stream generated from or separated from the liquid scrubbing solution that comprises an absorbed form of the targeted compound that can be used directly or after further processing as a product, such as a commercial or saleable product, such as a fertilizer.

### CROSS REFERENCE TO RELATED APPLICATIONS

This application claims the benefit of U.S. Provisional Application No. 63/697,219, filed Sep. 20, 2024, which is incorporated by reference herein in its entirety.

### BACKGROUND OF THE INVENTION

### Field of the Invention

The invention and its various embodiments relate to methods for removing a targeted component or compound from a gas stream to treat the gas stream prior to its subsequent processing by another process; to produce a liquid stream comprising an absorbed form of the targeted compound that can in turn be used directly, or after further processing, as a product, such as a commercial or saleable product; or to reduce wastewater discharge. In particular, in some embodiments, the methods can be used to process a hot multi-phase gas stream comprising ammonia, water, water vapor, fats, oils and greases, and solids, such as a waste gas stream from an animal byproduct process or a gas stream generated from animal manure processing, by removing the ammonia, as the targeted component, from the gas stream. These methods can be used, for example, to produce a liquid stream comprising an absorbed form of the ammonia that can be used as a fertilizer, including, for example, a fertilizer for use in organic agriculture. These methods can also be used as a pretreatment process upstream of a wastewater treatment system to reduce the amount of wastewater required to be treated.

### Description of Related Art

Techniques for removing certain components from gas streams are known. In some cases, the treatment of such gas streams can be complicated and energy intensive. Moreover, disposal of the resulting liquid and gas streams can be problematic and expensive. For example, in animal byproduct processing, such as rendering, processing of the animal byproduct material may result in odors requiring additional processing of waste gases and liquid streams.

Accordingly, there is a need for methods for removing certain components from certain gas streams such as industrial gas streams and waste gas streams. In particular, there is a need for methods for removing certain components form such gas streams to produce a removed compound that can, in turn, be used directly, or after further processing, as a product, such as a commercial or saleable product, such as a fertilizer. In some cases, there is a need to reduce wastewater discharges that would otherwise result from processing of such gas streams.

Further, organic agriculture or farming, which produces certified organic products, must comply with U.S. federal government regulations for organic farming and certified organic products, namely the National Organic Program (“NOP”) operated by the U.S. Department of Agriculture (“USDA”). Accordingly, particular attention is required to produce such natural or non-synthetic fertilizers or soil amendments, which results in higher production costs for such fertilizers and soil amendments. It should be appreciated that other states and agencies may have additional requirements that must be met to produce certified organic products.

One requirement for agricultural operations that produce “organic” or “certified organic” agricultural products is that such products must be produced without the use of synthetic chemicals. Accordingly, organic agricultural products must be produced using natural or non-synthetic substances. In fact, any natural or non-synthetic substance or chemical can be used in organic farming unless specifically prohibited by the USDA. The USDA maintains a list of allowed and prohibited natural substances, which is known as the “National List of Allowed and Prohibited Substances” (“National List”). The National List is well-known in the organic farming industry and is readily available from the USDA. As an example, some natural substances that are prohibited from being used in organic farming include arsenic and strychnine. It should be appreciated that various states, agencies, and other organizations maintain lists of approved materials, such as the California Department of Food and Agriculture, Washington State University, and the Organic Materials Review Institute.

Accordingly, to be compliant with the NOP statutes, rules, and regulations, such a fertilizer must be a natural or non-synthetic substance. The NOP at 7 U.S.C § 6502(21) defines “synthetic” as “a substance that is formulated or manufactured by a chemical process or by a process that chemically changes a substance extracted from naturally occurring plant, animal, or mineral sources, except that such term shall not apply to substances created by naturally occurring biological processes.”

Moreover, the USDA provides a well-known procedure for determining whether a substance is synthetic or non-synthetic. This procedure is found in the NOP Handbook provided by USDA (“Handbook”). The Handbook provides guidance, instructions, and policy memos to assist with compliance with NOP rules and regulations. The procedure for determining whether a substance is synthetic or non-synthetic is entitled “Guidance: Decision Tree for Classification of Materials as Synthetic or Nonsynthetic,” which is found in the Handbook at Section A Standards, NOP 5033-1.

Therefore, there is a need for methods that can produce fertilizers and soil amendments that can be used in organic agriculture or farming. Accordingly, there is a need for methods for removing certain components from certain gas streams, in particular, industrial gas streams and waste gas streams to recover a targeted compound, such as ammonia, and produce a commercial or saleable product, such as a fertilizer that can be used in organic agriculture or farming.

### BRIEF SUMMARY OF THE INVENTION

In general, the present invention is directed to methods or processes for treating a gas stream by removing one or more targeted compounds from the gas stream into a liquid scrubbing solution using, for example, absorption or scrubbing techniques. Generally, the methods of the present invention include passing the gas stream containing the targeted compound through a gas/liquid contactor and absorbing the targeted compound into a liquid scrubbing solution fed to the gas/liquid contactor. The liquid scrubbing solution is recycled through the gas/liquid contactor and a portion of the scrubbing solution is removed from the process, thereby removing the absorbed targeted compound from the process. Such treatment of the gas stream may be performed to produce a liquid stream generated from or separated from the liquid scrubbing solution that comprises an absorbed form of the targeted compound that can be used directly or after further processing as a product, such as a commercial or saleable product, such as a fertilizer. It should be appreciated that the absorbed form of the targeted compound is simply whichever chemical form the targeted compound takes upon being absorbed into the liquid scrubbing solution.

In some embodiments, the gas stream may be any gas stream from which certain compounds can be removed. In some embodiments, the gas stream may be a waste gas stream, such as a waste gas stream produced by an industrial process, such as an animal byproduct process, such as a rendering process. In some embodiments, the gas stream may be a gas stream derived or generated from animal manure, such as cow, pig, poultry, and human manures, such as a gas stream produced by the drying of such manures. In some embodiments, the gas stream may be a gas stream derived or generated from the effluent or digestate of a biogas process.

In some embodiments, the methods of the present invention are used to remove ammonia, as the targeted compound, from the gas stream. In these methods, the liquid stream into which the ammonia is absorbed can be used as, or processed to provide, a fertilizer. Accordingly, in those embodiments in which the gas stream is a waste gas stream produced by an animal byproduct process, such as a rendering process, or a gas stream derived from animal manure or a biogas effluent stream, ammonia may be the targeted compound to be removed from the gas stream to produce a fertilizer. Further, in some embodiments, the fertilizer produced by the methods of the present invention can be used as a fertilizer or soil amendment in an organic farming process that produces certified organic food products. In some embodiments, lactic or gluconic acid may be added to the scrubbing solution in the generation of a fertilizer product. In such cases, the acid solution may be heated to convert a portion of any oligomers back to the corresponding monomer in the acid solution.

### BRIEF DESCRIPTION OF THE SEVERAL VIEWS OF THE DRAWINGS

FIG. 1 is a process flow diagram illustrating a rendering process and related waste gas streams that may be treated according to the present invention;

FIG. 2 is a process flow diagram illustrating a process for removing a targeted chemical compound from a gas stream to produce a liquid stream comprising an absorbed form of the targeted compound for use as a saleable product (either directly or after further processing) according to one embodiment of the present invention;

FIG. 3 illustrates one source of a gas stream that can be treated by the process show in FIG. 2 according to one embodiment of the present invention;

FIG. 4 illustrates another source of a gas stream that can be treated by the process show in FIG. 2 according to one embodiment of the present invention;

FIG. 5 illustrates another source of a gas stream that can be treated by the process show in FIG. 2 according to one embodiment of the present invention;

FIG. 6 illustrates another source of a gas stream that can be treated by the process show in FIG. 2 according to one embodiment of the present invention; and

FIG. 7 is another process flow diagram illustrating a process for removing a targeted chemical compound from a gas stream to produce a liquid stream comprising an absorbed form of the targeted compound for use as a saleable product (either directly or after further processing) according to one embodiment of the present invention.

### DETAILED DESCRIPTION OF THE INVENTION

The present invention is more fully described below with reference to the accompanying drawings. While the invention will be described in conjunction with particular embodiments, it should be understood that the invention can be applied to a wide variety of applications, and it is intended to cover alternatives, modifications, and equivalents within the spirit and scope of the invention. Accordingly, the following description is exemplary in that several embodiments are described (e.g., by use of the terms “preferably,” “for example,” or “in one embodiment”), but this description should not be viewed as limiting or as setting forth the only embodiments of the invention, as the invention encompasses other embodiments not specifically recited in this description. Further, the use of the terms “invention,” “present invention,” “embodiment,” and similar terms throughout this description are used broadly and are not intended to mean that the invention requires, or is limited to, any particular aspect being described or that such description is the only manner in which the invention may be made or used.

In general, the present invention is directed to methods or processes for treating a gas stream by removing one or more targeted compounds from the gas stream into a liquid scrubbing solution using, for example, absorption or scrubbing techniques. Generally, the methods of the present invention include passing the gas stream containing the targeted compound through a gas/liquid contactor and absorbing the targeted compound into a liquid scrubbing solution fed to the gas/liquid contactor. The liquid scrubbing solution is recycled through the gas/liquid contactor and a portion of the scrubbing solution is removed from the process, thereby removing the absorbed targeted compound from the process. Such treatment of the gas stream produces a liquid stream generated from or separated from the liquid scrubbing solution that comprises an absorbed form of the targeted compound that can be used directly or after further processing as a product, such as a commercial or saleable product, such as a fertilizer. It should be appreciated that the absorbed form of the targeted compound is simply whichever chemical form the targeted compound takes upon being absorbed into the liquid scrubbing solution.

In some embodiments, the gas stream may be any gas stream from which certain compounds can be removed. The gas stream may be a multi-phase gas stream having components or compounds in solid, liquid, or gas form. In some embodiments, the gas stream may be an industrial gas stream produced by a process that is separate from the present invention, or the gas stream may be a gas stream produced in the same overall process but upstream of the process of the present invention. In some embodiments, the gas stream may be a waste gas stream, such as a waste gas stream produced by an industrial process, such as an animal byproduct process, such as a rendering process. In some embodiments, the gas stream may be a gas stream derived or generated from animal manure, such as cow, pig, poultry, and human manures, such as a gas stream produced by the drying of such manures. In some embodiments, the gas stream may be a gas stream derived or generated from the effluent or digestate of a biogas process.

As noted, in some embodiments, the gas stream may be a waste gas stream generated in an animal waste or byproduct process that processes waste animal tissue or animal parts, such as rendering. For example, the waste gas stream may be one or more gas streams generated by cooking, drying, concentrating (e.g., evaporating water and producing a water vapor gas stream), hydrolyzing (e.g., hydrolyzing of chicken feathers or pig hair), or blood drying processes. The present invention provides the ability to remove a targeted chemical compound, such as ammonia, from these gas streams prior to any condensing operation, thereby reducing or eliminating the collecting or condensation of ammonia in the water that is otherwise condensed. By reducing or eliminating the ammonia content in such condensate, a reduction in the burden on any subsequent wastewater treatment system is realized. It should be appreciated that many processes typically condense the water vapor in a given waste gas stream prior to any subsequent treatment of the waste gas stream, thereby removing various chemical compounds from the gas stream with the condensate. Such places a significant burden on any subsequent wastewater treatment system, even in those processes where the concentration of the targeted chemical compound, such as ammonia, is present in the condensate in a relatively low amount. The present invention reduces or eliminates this issue. Even treating a gas stream with a significant amount of water vapor and a relatively lower amount of a given targeted chemical compound, such as ammonia, with the methods of the present invention, allows for the removal of that targeted chemical compound prior to condensation, thereby reducing or eliminating the burden otherwise placed on the wastewater treatment system due to the presence of the targeted chemical compound in the condensate.

As noted, in some embodiments, the methods of the present invention are used to remove ammonia, as the targeted compound, from the gas stream. In these methods, the liquid stream into which the ammonia is absorbed can be used as, or processed to provide, a fertilizer. Accordingly, in those embodiments in which the gas stream is a waste gas stream produced by an animal byproduct process, such as a rendering process, or a gas stream derived from animal manure or a biogas effluent stream, ammonia may be the targeted compound to be removed from the gas stream to produce a fertilizer.

Further, in some embodiments, the fertilizer produced by the methods of the present invention can be used as a fertilizer or soil amendment in an organic farming process that produces certified organic food products. In these embodiments, the fertilizer is produced in a manner such that it is deemed to be a natural or non-synthetic substance and qualifies for use in organic agriculture or farming. It should be appreciated, however, that fertilizers produced by the methods of the present invention may also qualify for use in organic agriculture or farming according to governing regulations in countries other than the U.S.

In those embodiments in which ammonia is the targeted compound in the applicable gas stream, an acid can be added to the liquid scrubbing solution using pH control. The acid may be any suitable acid; however, in those embodiments in which the production of a fertilizer is desired, the acid should be an acid having a corresponding ammonium salt form suitable as a fertilizer. For example, organic acids may be used, including organic acids such as citric acid, acetic acid, lactic acid, fulvic acid, humic acid, or gluconic acid or other fermented acids, including non-synthetic forms of such acids. It should also be appreciated that other acids, including synthetic or non-synthetic acids may be used, such as sulfuric, nitric, phosphoric, and hydrochloric acids.

In some embodiments, lactic or gluconic acid may be used. In these embodiments, solutions of lactic or gluconic acid may form oligomers, such as dimers and trimers. As a result, the concentration of free or monomeric lactic or gluconic acid is reduced and the effectiveness of the acid in removing ammonia is similarly reduced. In such cases, the acid solution may be heated to convert a portion of the oligomers back to the corresponding monomer in the acid solution.

It should further be appreciated that the use of non-synthetic or natural acid, such as non-synthetic or natural organic acids, including, for example, lactic acid, gluconic acid, citric acid, acetic acid, humic acid, or other fermented acids may be used to generate a fertilizer or soil amendment that qualifies for use in organic agriculture or farming. It should be appreciated that the acid is used to react with absorbed ammonia to produce a corresponding dissociated ammonium in solution constituting a product for use as a fertilizer. For example, the use of lactic or gluconic acid would result in a disassociated ammonium lactate or ammonium gluconate. It should also be appreciated that other acids, including synthetic or non-synthetic acids may be used, such as sulfuric, nitric, phosphoric, and hydrochloric acids.

In some embodiments, the present invention provides for various other operating scenarios. The present invention provides for the ability to control the temperature of the gas stream being treated to provide for enhanced absorption of the targeted chemical compound by adding air to the gas stream prior to any treatment. Also, it should be appreciated that in some embodiments, the gas stream temperature may be high enough that it causes pump cavitation due to the resulting operating temperature of the overall system. Accordingly, it may be desirable to reduce the gas stream temperature entering the gas/liquid contactor by adding ambient air to the gas stream. In a rendering process, for example, air may be added downstream of the cooker and upstream of the gas/liquid contactor. As described further below, because the cooker operates at a vacuum, a fan can be used to control the gas flow through the system based upon the desired vacuum at the cooker.

In other embodiments, the temperature of the gas stream, particularly in cases in which there is a relatively higher amount of water vapor, may be increased to avoid condensation of the water vapor by the addition of heat to the gas stream upstream of the gas/liquid contactor. Further, the temperature of the gas/liquid contactor may also be controlled by adding heat to the scrubbing solution.

Additionally, the present invention provides for the treatment of vapors that condense within any gas ductwork within the overall process. The condensed vapors can be collected from those ducts and returned or recycled back to the system.

Following, various specific embodiments of the present invention are described in connection with each of the Figures. The description associated with each figure may describe various alternatives, including various process configurations and equipment, as well as additional features and aspects of the present invention. However, these descriptions should not be viewed as limiting or required for the overall present invention.

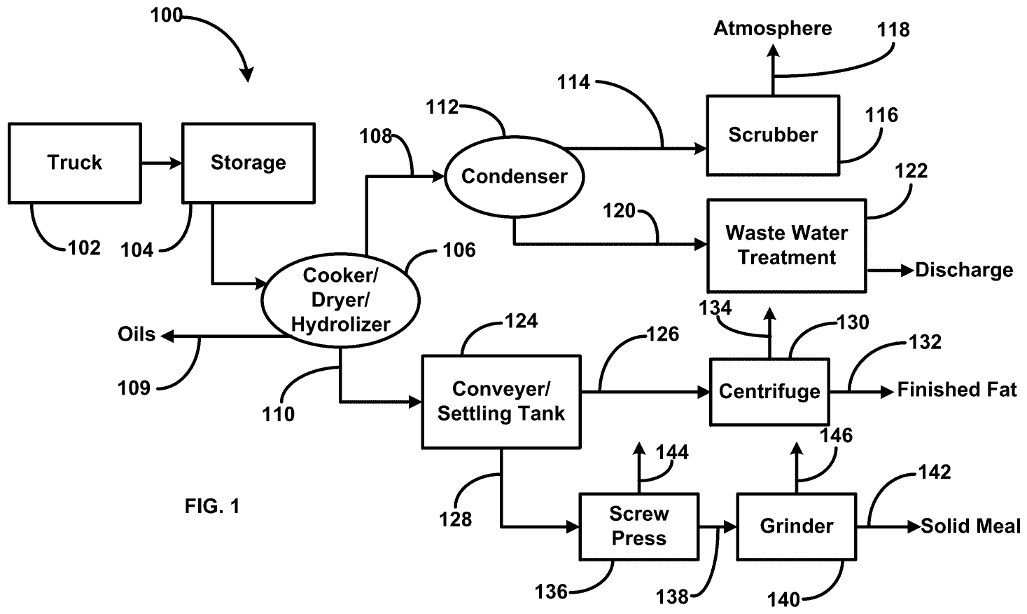

FIG. 1 is a process flow diagram illustrating a rendering process and related waste gas streams that may be treated according to the present invention. It should be appreciated, however, that FIG. 1 is exemplary of one process in which waste gas streams can be treated by the present invention, as the present invention has application in other processes for treating a waste gas stream as described further below. Accordingly, FIG. 1 is provided as one exemplary context for the present invention.

In this process 100, a truck 102 will typically dump various animal byproduct materials into a storage tank 104. This byproduct material is fed to a cooker 106, which may be a rotary or disk dryer or hydrolizer. The cooker 106 adds heat to the byproduct material to drive off water as an aerosol and/or vapor and to separate fat from the bone and protein. As a result, the cooker 106 produces a waste gas stream 108, an oils stream 109, and a solids stream 110. It should be appreciated that if a rotary or disk dryer or hydrolizer is used, typically only two streams are produced, a waste gas stream and a solids stream that also comprises oils. It should be appreciated that the waste gas stream may also contain entrained liquid, solids, or both.

The waste gas stream 108 from the cooker 106, which contains various odorous, noxious, hazardous, toxic, mutagenic, and/or carcinogenic compounds and/or precursor compounds, is passed to a ambient temperature air or water condenser 112 where the waste gas stream 108 is cooled to partially condense gases and to remove any entrained liquids and/or solids through, for example, agglomeration or combination of entrained liquids and solids together or onto newly condensed gases or vice versa, thereby separating as many of the condensable chemical vapors, solid particulates, smoke particulates, aerosols, and water vapor from the waste gas stream. In processes currently used in the rendering industry, condensing of the waste gas stream 108 is done using either ambient air in an air cooled condenser or surface water, well water, or recycle water in a tube and shell condenser. In all of these cases, however, the temperature of the cooling media is usually ambient temperature (noting that in some cases a cooling tower may be used to cool the cooling water but still to within a few degrees of ambient) such that a portion of the waste gas stream does not condense in the condenser 112, which may require additional treatment prior to discharge to breathing spaces and/or the atmosphere.

The ambient temperature condenser 112 produces a lower volume waste gas stream 114, which contains various odorous, noxious, hazardous, toxic, mutagenic, and/or carcinogenic compounds and/or precursor compounds that were not condensed, that is subsequently passed to a scrubber 116 where at least portions of certain components are removed from the waste gas stream, including certain portions of the remaining odorous, noxious, hazardous, toxic, mutagenic, and/or carcinogenic compounds and/or precursor compounds. It should be appreciated that this gas stream 114 could bypass a subsequent scrubbing step and be directly treated in a combustion device. Alternatively, this gas stream 114 could be further processed in a venturi, scrubbed multiple times, and combusted. This gas stream 114 could also be combined with other process gas streams from other process steps, such as those from the centrifuge, 130, screw press 136, etc. and treated using a venturi and scrubber or multiple scrubbing steps and emitted to the environment or further processed through using a combustion device. The combustion device could be a thermal oxidizer, regenerative thermal oxidizer, boiler, or any other suitable thermal oxidizer. The scrubber 116 discharges the remaining waste gas stream 118 to breathing spaces and/or the atmosphere.

The condenser 112 also produces a condensate stream 120 that is passed to a wastewater treatment system 122 for ultimate discharge. The wastewater treatment system 122 may include a wastewater pre-treatment system that separates sludge, liquid, and solids from each other prior to discharge. It should be appreciated that the wastewater pre-treatment system 122 may be a diffused or induced air flotation system because the solids and oil are more likely to separate and float than separate and sink. In some cases the wastewater pre-treatment system 122 may include biological digestion of the soluble fraction that is measured as biological oxygen demand, as well as the use of nitrifying bacteria to remove the nitrogen loading prior to surface discharge or discharge to a municipality. It should be appreciated that instead of a condensate stream 120 being passed to a wastewater treatment system 122, the condensate stream 120 can be further treated and refined to concentrate the ammonia to create an organic fertilizer product.

The solids stream 110 from the cooker 106 is passed to a conveyor/settling tank 124 that further separates solids from liquids to produce a liquid stream 126 and another solids stream 128. The liquid stream 126 is processed by a centrifuge 130, which produces a stream of finished fat 132 for sale or for further processing and refinement. Vapors, solid particulates, smoke particulates, aerosols and water vapor 134 are also produced during operation of the centrifuge 130 that may contain odorous, noxious, hazardous, toxic, mutagenic, and/or carcinogenic compounds and/or precursor compounds. The solids stream 128 is further processed by a screw press 136 that produces a relatively more dry solids stream 138 that may be sent to a grinder 140 to grind the solids into a more uniform particle size distribution for sale as meal 142. Operation of both the screw press 136 and the grinder may result in the production of chemical vapors, solid particulates, smoke particulates, aerosols, oils and solids (noting that the screw press 136 is used to press the oil out of the finished cooked material), and water vapor 144, 146, respectively, that may each include odorous, noxious, hazardous, toxic, mutagenic, and/or carcinogenic compounds and/or precursor compounds. Accordingly, it should be appreciated that there are at least four possible sources of chemical vapors, solid particulates, smoke particulates, aerosols, and water vapor or vapor dominated multi-phase process waste streams that may contain odorous, noxious, hazardous, toxic, mutagenic, and/or carcinogenic compounds and/or precursor compounds, including the waste gas stream 114 produced by the “ambient temperature” condenser 112, which includes the partially condensed odorous, noxious, hazardous, toxic, mutagenic, and/or carcinogenic compounds and/or precursor compounds, the chemical vapors, solid particulates, smoke particulates, aerosols, and water vapor 134 produced from the centrifuge 130, the chemical vapors, solid particulates, smoke particulates, aerosols, and water vapor 144 produced from the screw press 136, and the chemical vapors, solid particulates, smoke particulates, aerosols, and water vapor 146 produced from the grinder 140. In some rendering processes these various waste gas streams are further treated to remove odorous, noxious, hazardous, toxic, mutagenic, and/or carcinogenic compounds and/or precursor compounds by feeding such streams to an existing boiler or the various embodiments of thermal oxidation for incineration. In these cases, additional fuel for the boiler is required or a thermal oxidation device must be purchased and operated incurring additional capital and operating costs. The typical rendering waste gas stream contains solid particulates, smoke particulates, aerosolized oils, fats, greases, tallow, and waxes that can corrode, erode or create deposits within boilers and thermal oxidation equipment which then requires frequent cleaning and repairs.

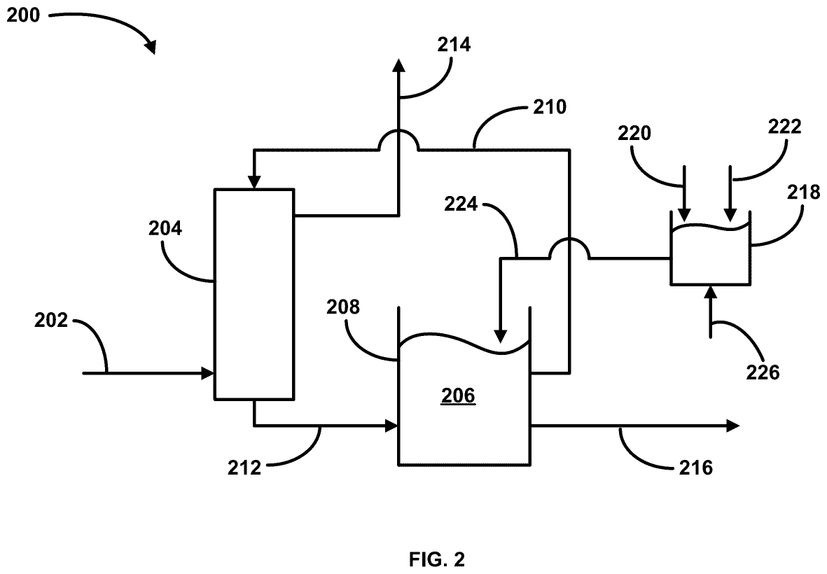

FIG. 2 is a process flow diagram illustrating a process for removing a targeted chemical compound from a gas stream to produce a liquid stream comprising an absorbed form of the targeted compound for use as a saleable product (either directly or after further processing) according to one embodiment of the present invention. The process 200 shown in FIG. 2 illustrates the processing of a gas stream 202 comprising a targeted chemical compound. In operation, the process of the present invention provides for the absorption of the targeted chemical compound from the gas stream 202 into a liquid scrubbing solution 206 using a gas/liquid contactor 204. Once absorbed, the targeted chemical compound is converted into an absorbed form, which is the chemical composition into which the targeted chemical compound is converted upon absorption in the scrubbing solution 206. The specific chemical composition of the absorbed form depends upon the specific composition and phase of the targeted chemical compound and the composition of the scrubbing solution 206. Accordingly, in some embodiments, the absorbed form may simply be the hydrated form of the targeted chemical compound. In some embodiments, the targeted chemical compound may be a nitrogen-based compound, such as ammonia.

The gas stream 202 may be any gas stream that has a targeted chemical compound, which may be in gaseous, liquid, or solid form in the gas stream. For example, the gas stream may be a waste gas stream from an industrial process or a process gas stream used within such a process. In some embodiments, the waste gas stream may be from an industrial process such as an animal byproduct process, a rendering process, or an animal manure drying process. In some embodiments, the gas stream may be produced by a particular step or operation in the industrial process, such as an animal byproduct process, a rendering process, regardless of where in the overall process such steps occur. For example, the gas stream may be produced as a result of drying, cooking, or evaporating. In some embodiments, the gas stream may be a gas stream produced by a piece of equipment, such as a dryer or evaporator, in such a process. In some embodiments, the gas stream may be a heated gas stream or a gas stream produced by a piece of equipment that imparts heat to the gas stream, such as a dryer or evaporator in a rendering process or a manure or animal waste dryer, thereby providing a gas stream with a given heat content. It should be appreciated that the gas stream may also comprise various other chemical compounds, including compounds that may be in gaseous, liquid, or solid form in the gas stream. For example, a waste gas stream generated by a dryer in a rendering process may contain fats, oils and greases, and solids.

For example, in some embodiments, the gas stream may be one or more waste gas streams produced by the rendering process of FIG. 1. For example, the gas stream may be a vapor discharge stream produced from a cooker, hydrolyzer, dryer, evaporator, or concentrator in the rendering process. For example, infall placed in the cooker is heated, resulting in the production of a vapor discharge stream, an oil-based discharge stream, and a solids discharge stream. In a rendering process, these vapor discharge streams contain a significant amount of gas phase nitrogen compounds, including ammonia, derived from the infall. Accordingly, any one or more of these vapor discharge or exhaust gas streams may comprise, separately or in combination, the gas stream containing the targeted chemical compound for treatment. It should be appreciated that in those embodiments in which the gas stream is a waste gas stream from animal byproduct process, such as a rendering process, or an animal manure drying process the targeted chemical compound may be ammonia.

The targeted chemical compound is a chemical or compound, the removal of which provides a product such as a commercial or saleable product. In such embodiments, the process 200 can be used to produce a liquid stream comprising an absorbed form of the targeted compound that can be used directly, or after further processing, as a product, such as a commercial or saleable product. It should be appreciated that in some embodiments the targeted chemical compound may be captured from the gas stream and provided in solution as a product or isolated and provided in that isolated form as a product. In some embodiments, the targeted chemical compound is a nitrogen-based compound, such as gas phase ammonia, the recovery of which, either as a solution or in a subsequently dried form, can be used as a general fertilizer or soil amendment. In some embodiments, the targeted chemical compound is gas phase ammonia, the recovery of which as a solution can be used as a fertilizer or soil amendment in an organic farming process that produces certified organic food products.

In addition, the removal of the targeted chemical compound may produce a gas stream for further processing with a lower concentration of the targeted chemical compound that can be further processed with operational efficiencies or cost savings. For example, the removal of a particular targeted chemical compound may provide a gas stream with a lower concentration of the targeted gas phase chemical compound that may be more easily processed as a result. In other words, the removal of the targeted compound reduces the amount of further processing required for the gas stream or improves the efficiency or operation of such further processing. For example, the gas stream may contain compounds that must be removed prior to discharge to comply with certain emission regulations. In some embodiments, these compounds may be removed by condensing the gas stream, thereby condensing certain components and forming a liquid stream that is treated by a wastewater treatment system. In this case, the process of the present invention acts as a pretreatment step for the wastewater treatment system by removing a targeted chemical compound from the gas stream that may reduce the burden on the subsequent wastewater treatment system. For example, in some embodiments, the targeted chemical compound may be ammonia. By removing ammonia from the gas stream, subsequent condensation of the gas stream to condense other compounds that must be removed into a liquid stream that is treated by a wastewater treatment system, results in lower ammonium concentration in that liquid stream, thereby reducing the burden or load of ammonium on the wastewater treatment system.

The gas/liquid contactor 204 may be any gas/liquid contactor known in the art, such as, but not limited to, a scrubber, a spray tower, a tray absorber, a packed bed absorber, or a bubbler. The gas/liquid contactor 204 may be operated in a counter-current fashion, co-current fashion, or cross-current fashion or in any other manner that provides sufficient contact between a gas and a liquid. It should be appreciated that the use of a packed bed provides for a relatively higher residence time or greater contact between the gas and the scrubbing solution, which may result in relatively higher absorption of the targeted chemical compound, and in the embodiment in which an acid is added to the scrubbing solution, such as any of the organic acids described above, that the acid requirement may be relatively lower. It should be appreciated that more than one gas/liquid contactor 204 may be used in series or in parallel. The gas/liquid contactor 204 is operated by passing a liquid scrubbing solution 206 from a sump or recycle tank 208 through a recycle line 210 and through the gas/liquid contactor 204 such that the gas stream 202 is contacted by the liquid scrubbing solution 206. The targeted chemical compound is absorbed or scrubbed by the liquid scrubbing solution 206. Accordingly, the composition of the liquid scrubbing solution 206 may be adapted to enhance absorption of the targeted chemical compound. In such cases, chemicals may be added to the liquid scrubbing solution, for example, to replenish any chemicals depleted during absorption.

Additionally, pH control may be used for absorption of certain acidic or basic targeted chemical compounds. During absorption, the targeted chemical compound passes from the gas stream 202 into the liquid scrubbing solution 206. The pH may be selected based upon the specific targeted chemical compound being removed and may be controlled at that pH during operation using the addition of acid or base as necessary using either feedback or feedforward control. It should be appreciated that any acid may be used that is compatible with the overall system chemistry, including the desired end use of the liquid stream comprising the absorbed form of the targeted compound in those cases in which the liquid stream is a desired product. In some embodiments, such control can be done through the addition of the acid or carbon dioxide addition. The addition of acid or base can be performed by adding such acid or base to either the sump 208 or the recycle line 210. It should also be appreciated that an overall water balance for the process 200 would be controlled through the balancing of water added and removed from the process 200.

The scrubbing solution 206 can be recycled through the gas/liquid contactor 204. In this case, the liquid scrubbing solution 206 is fed to the gas/liquid contactor 204 in which it contacts the gas stream 202 resulting in absorption of the targeted chemical compound into the scrubbing solution 206. The scrubbing solution 206 then exits the gas/liquid contactor 204 as a scrubbing solution with the absorbed form of the targeted chemical compound and is passed through an effluent line 212 back to the sump 208. It should be appreciated that the sump 208 may also be integral to the gas/liquid contactor 204 such that the effluent line 212 is unnecessary. Alternatively, it should be appreciated that the liquid scrubbing solution 206 may be used as a single-pass or in a once-through fashion such that the liquid scrubbing solution only passes through the gas/liquid contactor 204 one time. After absorbing the targeted gas phase chemical compound from the gas stream 202, the gas stream 202 exits the gas/liquid contactor 204 through an exit duct 214 with a lower concentration of the targeted gas phase chemical compound.

A portion of the liquid scrubbing solution held in the sump 208 is discharged as a liquid stream or product stream 216. This product stream 216 is a liquid solution containing the absorbed form of the targeted chemical compound. The product stream 216 can be used directly, or after further processing, as a product, such as a commercial or saleable product, which may include its use in another process. Such further processing may include, for example, processing the product stream 216 to isolate the absorbed form of the targeted chemical compound for further use, such as drying the product stream 216 to provide a dried form of the absorbed targeted compound.

In some embodiments, the targeted chemical compound is ammonia such that the product stream 216 may be a liquid stream comprising disassociated ammonium hydroxide or ammonium cation that can be used directly as a fertilizer. Alternatively, or in addition, the product stream 216 can be further processed, for example, by removing water to concentrate the ammonium and provide a dried form of the ammonium for use as a fertilizer. It should be appreciated that in some embodiments, it may be desirable to rehydrate the dried form of the targeted compound at the point of use, which can be easily done by any means known in the art.

In those embodiments in which the targeted chemical compound is ammonia, the liquid scrubbing solution 206 can be operated by adding an acid to the scrubbing solution 206. The use of an acid acts to increase the solubility, and therefore the removal, of the ammonia from the gas stream 202. Accordingly, this embodiment enables treatment of a gas stream having a relatively higher concentration of ammonia.

As shown in FIG. 2, an acid feed tank 218 may be used to hold the acid solution, which can be generated by the addition of the acid 220 and a predetermined amount of solvent or water 222. FIG. 2 illustrates the addition of the acid from the acid feed tank 218 through an acid feed line 224 to the sump 208. Alternatively or in addition, it should be appreciated that the acid may be added directly to the liquid scrubbing solution 206 in the recycle line 210 as it is fed to the gas/liquid contactor 204. Alternatively or in addition, the acidic solution can be sprayed into the gas stream 202 upstream of the gas/liquid contactor 204. It should be appreciated that the acid can be added as a solution by spraying the acidic solution into the gas stream 202 upstream of the gas/liquid contactor 204.

It should be appreciated that any acid may be used. For example, organic acids may be used, including organic acids such as citric acid, acetic acid, lactic acid, humic acid, or gluconic acid or other fermented acids, including non-synthetic forms of such acids. It should also be appreciated that other acids, including synthetic or non-synthetic acids may be used, such as sulfuric, nitric, phosphoric, and hydrochloric acids. In some alternative embodiments, carbon dioxide can be injected into the liquid scrubbing solution 206 to reduce or control the pH. Similarly, the carbon dioxide can be added to the gas stream 102 upstream of the gas/liquid contactor 204 or sparged or bubbled into the sump 208.

In some embodiments, lactic or gluconic acid may be used. In some embodiments, the lactic acid 220 as added to the acid feed tank 218 may be approximately 88% lactic acid, which may then be diluted with water 222 to approximately 60-70 percent. It should be appreciated that other concentrations of acid may be used, such as 100 percent lactic acid. It should also be appreciated that the concentration of the acid may be adjusted, for example, by dilution with water, to meet a desired concentration of product produced from the targeted compound or to optimize operation of the overall process. However, in these embodiments, it should be appreciated that the free acidity of the acid in the scrubbing solution is determinative of the effectiveness of the acid being added. Solutions of lactic or gluconic acid may contain oligomers in the acid feed tank 218 prior to addition to the scrubbing solution 206. As a result, the concentration of lactic or gluconic acid itself as a monomer or free acid is lower than the total measured concentration of the acid, and the effectiveness of the acid in removing ammonia is consequently lower. In such cases, heat 226 may be added to the acid feed tank 218 to convert a portion of the oligomers back to the corresponding monomer or free acid in the acid solution. For example, in some embodiments, supplied lactic acid is diluted to approximately 60% followed by heating at 80° C. to break-up the oligomers or until the free acidity of lactic acid is at a desirable level or at a maximum, which in some embodiments may take approximately 15-20 hours, or closer to 20 hours, or 20 hours.

It should be appreciated that the use of non-synthetic or natural acid, such as non-synthetic or natural organic acids, including, for example, lactic acid, gluconic acid, citric acid, acetic acid, humic acid, or other fermented acids may be used to generate a fertilizer or soil amendment that qualifies for use in organic agriculture or farming. It should be appreciated that the acid is used to react with absorbed ammonia to produce a corresponding dissociated ammonium in solution constituting a product for use as a fertilizer. It should also be appreciated that other acids, including synthetic or non-synthetic acids may be used, such as sulfuric, nitric, phosphoric, and hydrochloric acids.

It should be appreciated that depending upon the acid used, the product will be the corresponding ammonium compound, which may be used as a fertilizer. For example, if lactic acid is used, the corresponding product will be ammonium lactate. Further, if the acid used is a non-synthetic acid, the corresponding product can be used in organic farming to produce certified organic products.

It should also be appreciated that when using an acid, in some embodiments, the gas/liquid contactor may be a packed bed absorber. In this case, the residence of the scrubbing solution in the gas/liquid contactor is increased, thus resulting in higher contact time between the gas and the scrubbing solution. This may result in additional absorption of the targeted chemical compound, such as ammonia, and a reduction in the amount of acid required.

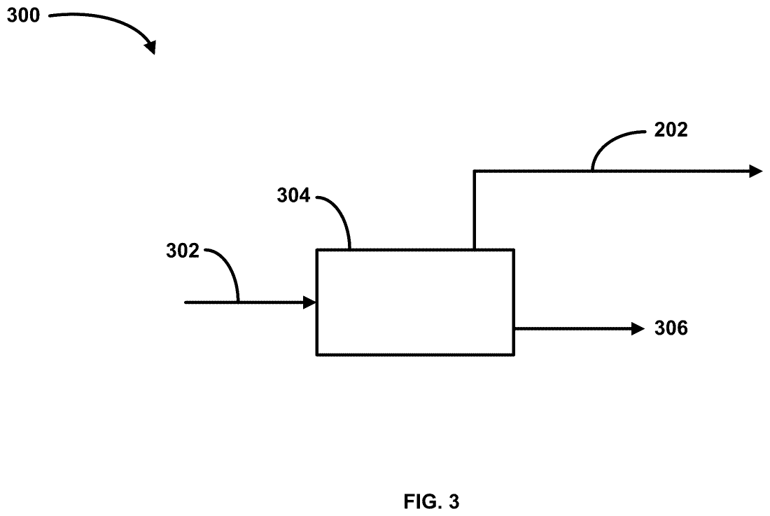

FIG. 3 illustrates one source of a gas stream that can be treated by the process show in FIG. 2 according to one embodiment of the present invention. The process 300 shown in FIG. 3 illustrates an animal manure drying process. Animal manure 302 may be processed by feeding the manure 302 to a dryer 304. In the dryer 304, a gas stream containing ammonia is evolved from the manure 302 and exits the dryer 304 as the gas stream 202 to be treated according to the process of FIG. 2. It should be appreciated that any type of manure may be used as a source of the ammonia in this process. Further, the manure may be blended with a liquid animal waste stream containing ammonium that would also be released into the gas stream 202 thereby allowing the capture of additional ammonia in the process of FIG. 2.

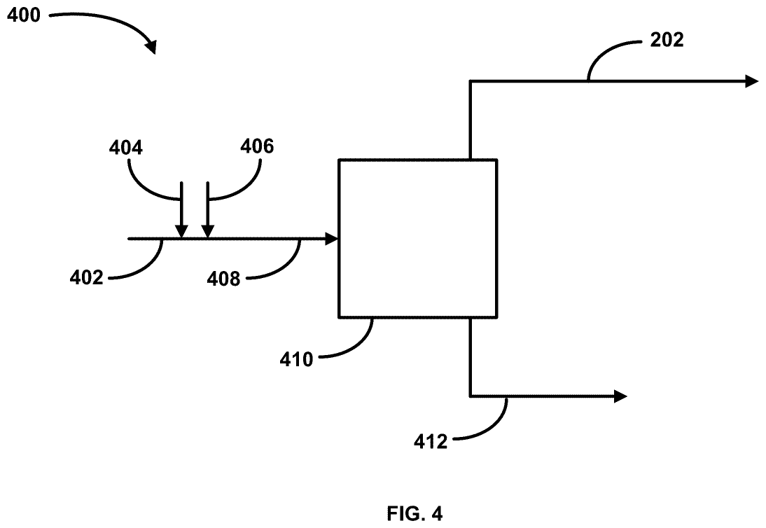

FIG. 4 illustrates another source of a gas stream that can be treated by the process show in FIG. 2 according to one embodiment of the present invention. As shown in the process 400, the source of the gas stream 202 that is treated according to the process of FIG. 2 may originate from one or more liquid streams 402, 404, 406 containing a form of the targeted chemical compound. For example, one or more liquid streams 402, 404, 406 may contain ammonium, such as various waste liquid streams from any industrial process, including an animal byproduct process, such as rendering, or an animal manure processing facility. For example, with reference to FIG. 1, liquid streams produced by any of the equipment shown, such as the cooker/dryer/hydrolizer 106, the condenser 112, the centrifuge, etc. may be processed in this manner. These streams may be combined into one liquid stream 408 and passed to a stripper or heater 410 that strips or vaporizes the ammonium into gas phase ammonia, which exits the stripper or heater 410 as the gas stream 202. A liquid discharge stream 412 may also exit the stripper or heater 410 for disposal or further processing. Accordingly, the gas stream 202 produced in this manner is treated by the process of FIG. 2 as described above in connection with FIG. 2. It should be appreciated that other liquid streams containing the targeted chemical compound, such as liquid collected from any gas ductwork in which a portion of the gas has condensed. Alternatively, it should be appreciated that such liquid streams may also be collected and returned to the sump 208 or to the gas/liquid contactor 204.

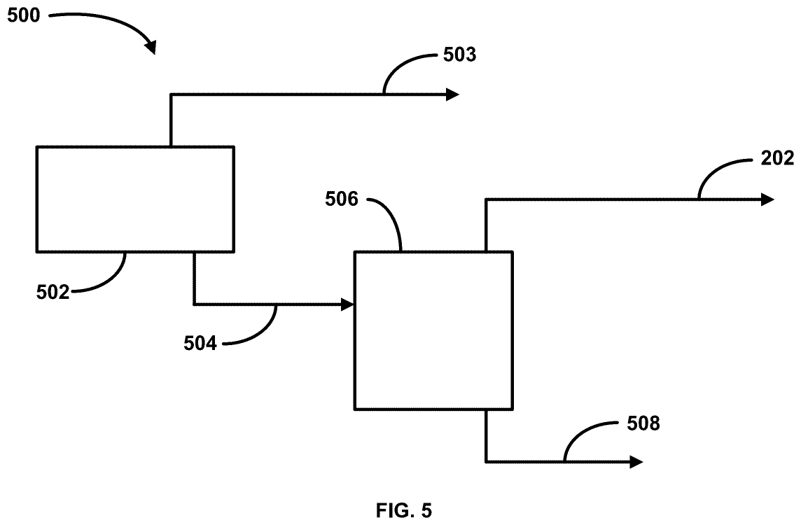

FIG. 5 illustrates another source of a gas stream that can be treated by the process show in FIG. 2 according to one embodiment of the present invention. As shown in the process 500, the source of the gas stream 202 is generated from a biogas process. As shown, a biogas reactor or digester 502 is used to produce biogas 503 but also a liquid effluent stream 504 that contains ammonium. This effluent stream 504 is passed to a stripper or heater 506 that strips or vaporizes the ammonium into gas phase ammonia, which exits the stripper or heater 506 as the gas stream 202. A liquid discharge stream 508 may also exit the stripper or heater 506 for disposal or further processing. Accordingly, the gas stream 202 produced in this manner is treated by the process of FIG. 2 as described above in connection with FIG. 2. In another embodiment, the biogas 503 produced by the biogas reactor 502 may also be processed as the gas stream 202.

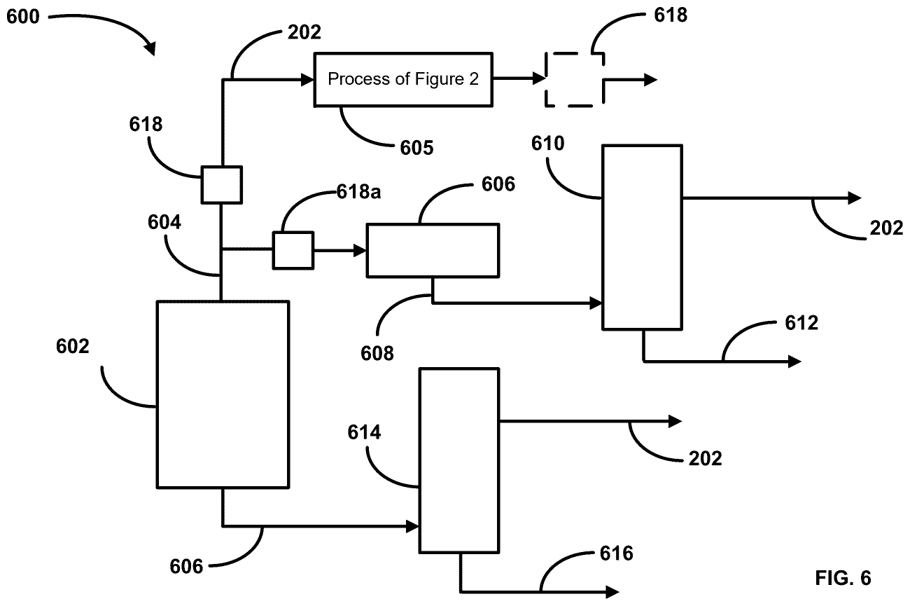

FIG. 6 illustrates another source of a gas stream that can be treated by the process show in FIG. 2 according to one embodiment of the present invention. As shown in the process 600, the source of the gas stream 202 that is treated according to the process of FIG. 2 may originate as a gas stream or from one or more liquid streams containing a form of the targeted chemical compound.

In this process, a vacuum evaporator 602 is used to treat a solution of biosolids with the addition of microbes to digest the biosolids and to produce an evaporated gas stream or biogas stream 604 and a liquid concentrate stream 606. Depending upon the operating conditions of the vacuum evaporator 602, the biogas stream 604 may have varying amounts of a given targeted compound, such as ammonia. Accordingly, the biogas stream 604 itself may, in one embodiment, be used directly as the gas stream 202 in the process of FIG. 2 605. In this case, and with ammonia as the targeted compound, it is preferable to operate the vacuum evaporator 602 under conditions in which the evaporated ammonia remains in the gas phase in the biogas stream 604, as opposed to condensing within the vacuum evaporator 602 itself. It should be appreciated that in this embodiment, the vacuum pump 618 may be placed either upstream or alternatively downstream (as shown in dashed lines) of the process of FIG. 2 605.

Alternatively, or in addition, the biogas stream 604 may be sent to a condenser 606 to produce a condensate stream 608 containing a condensed form of the targeted compound, such as ammonia. The condensate stream 608 may then be passed to a stripper or heater 610 that strips or vaporizes the condensed form of the targeted compound back into the corresponding gaseous form. For example, the biogas stream 604 may have gaseous ammonia, which may be condensed into a condensed form, such as ammonium, in the condenser 606 and then stripped in the stripper 610 into the corresponding gaseous form, such as ammonia. The gas stream 202 exiting the stripper or heater 610 then serves as the gas stream 202 to be treated according to the process of FIG. 2. A liquid discharge stream 612 may also exit the stripper 610 for disposal or further processing. It should also be appreciated that depending upon whether the entirety of the biogas stream 604 is sent to the condenser 606 or directly to the process of FIG. 2 605, or a combination thereof, a vacuum pump 618a may be needed upstream of the condenser 606.

Alternatively, or in addition, and depending upon the operating conditions of the vacuum evaporator 602, the liquid centrate stream 606 may similarly contain the targeted compound or a dissolved form of the targeted compound. In this embodiment, the liquid centrate 606 is similarly sent to stripper or heater 614 to strip or vaporize the condensed form of the targeted compound into the corresponding gaseous form. The gas stream 202 exiting the stripper or heater 614 then serves as the gas stream 202 to be treated according to the process of FIG. 2. A liquid discharge stream 616 may also exit the stripper 610 for disposal or further processing. It should be appreciated that in circumstances where both the centrate stream 606 and the condensate stream 608 both contain the dissolved form of the targeted compound these streams may be sent to the same stripper or heater or combined and then sent to the same stripper or heater.

It should be appreciated that depending upon the source of the biosolids, the resulting gas streams and the targeted compound may be suitable as fertilizers or soil amendments for use in the production of certified organic products. It should also be appreciated that the vacuum evaporator 602 may be used upstream or downstream of an anaerobic digester. U.S. Patent Application Publication No. 2022/0267183, entitled “Methods and Systems for Treating Fluid Using a Biochemical Process Under Vacuum Pressure,” which provides additional details regarding the operation and use of such a vacuum evaporator, is incorporated herein by reference. See Santoro, et al. “Methods and Systems for Treating Fluid Using a Biochemical Process Under Vacuum Pressure,” U.S. Patent Application Publication No. 2022/0267183, Aug. 25, 2022.

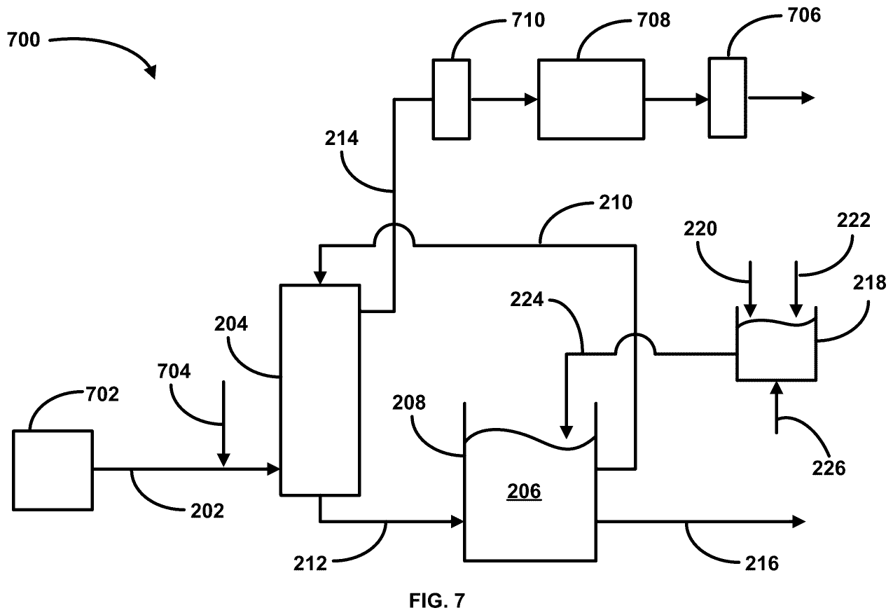

FIG. 7 is another process flow diagram illustrating a process for removing a targeted chemical compound from a gas stream to produce a liquid stream comprising an absorbed form of the targeted compound for use as a saleable product (either directly or after further processing) according to one embodiment of the present invention. The process 700 is similar to that of FIG. 2, with the exception that the process 700 provides for additional control over the temperature in the gas/liquid contactor 204. Accordingly, all of the description above in connection with FIG. 2 is equally applicable to FIG. 7.

As described above, the gas stream 202 containing the targeted chemical compound may derive from various sources. In this particular embodiment, at least one source is a cooker 702 in a rendering process. Again, it should be appreciated that other sources of gas may be combined to form the gas stream 202. The cooker 702 produces a gas stream containing the targeted chemical compound, which in this embodiment is ammonia. The gas stream produced by the cooker 702 may be superheated, which may result in downstream pump cavitation.

Accordingly, it is desirable to control the temperature of the gas stream 202 entering the gas/liquid contactor 204 from the cooker 702. This is accomplished by adding air 704 to the gas stream 202 (produced by the cooker 702) upstream of the gas/liquid contactor 204. The addition of ambient air, which is at a temperature less than that of the gas stream 202 from the cooker 702, results in a decrease in the gas stream temperature at the inlet of the gas/liquid contactor 204. The amount of air 704 that is added can be controlled based upon the gas stream temperature at the inlet of the gas/liquid contactor 204. It should be appreciated that in some embodiments, it is desirable to control the temperature of the gas stream 202 so as to not condense any condensable components, including water and the targeted chemical compound, upstream of the gas/liquid contactor 204. Accordingly, providing a relatively lower gas stream temperature without condensation improves the solubility of the targeted chemical compound, such as ammonia, in the scrubbing solution 206. Because the cooker 702 is designed to operate at a vacuum, a fan 706 is positioned downstream and can be adjusted to control the flow of the gas stream 202 through the overall process 700 to maintain the desired vacuum at the cooker 702. It should be appreciated, however, that the fan 706 can be placed at any location downstream of the gas/liquid contactor 204. It should be appreciated that such a fan may be used in connection with the treatment of other gas streams being treated in addition to those generated by a rendering process.

Additionally, a condenser 708 may be positioned downstream of the gas/liquid contactor 204 and upstream of the fan 706. The condenser 708 is used to condense certain components, including water, in the exit gas stream 214. In some embodiments, the condenser 708 is used to condense certain compounds from the gas stream 214, for example, to meet any regulatory discharge requirements, followed by treatment of the resulting liquid stream prior to discharge, such as treatment in a wastewater treatment facility. In this case, the process of the present invention acts as a pretreatment step for any wastewater treatment system by removing a targeted chemical compound from the gas stream that may reduce the burden on the subsequent wastewater treatment system. It should be appreciated, however, that the upstream removal of ammonia in the gas/liquid contactor 204 and subsequent condensation of the exit gas stream 214 in the condenser 708 to condense other compounds that must be removed into a liquid stream that is treated by a wastewater treatment system, results in lower ammonium concentration in that liquid stream, thereby reducing the burden or load of ammonium on any wastewater treatment system.

It should also be appreciated that in some embodiments, an evaporator 710 may also be used in which heat from the gas is recovered and used to heat another stream. As shown, the evaporator 710 is positioned downstream of the gas/liquid contactor 204 and upstream of the condenser 708, noting that some condensate may form as a result of the transfer of heat from the gas stream 214 in the evaporator 710. This condensate may contain the targeted chemical compound, ammonia in this embodiment, which can be sent back to the gas/liquid contactor 204 or the sump 208. Alternatively, the evaporator 710 may be positioned downstream of the condenser 708 to minimize the condensation of any ammonia in the evaporator 710.

It should be appreciated that in other embodiments, the gas stream to be treated may be such that heating of the gas stream or heating of the scrubbing solution may be desirable. For example, in those cases in which the gas stream to be treated contains a significant amount of water content or is approaching or close to saturation, condensation of that water vapor, for example, in the gas/liquid contactor may be reduced or avoided by adding heat to the gas stream to be treated prior to entering the gas/liquid contactor. Any means known in the art for heating a gas stream may be used. Additionally, or in the alternative, the scrubbing solution may similarly be heated. Similarly, any means known in the art for heating a liquid stream may be used. For example, a heat exchanger may be used to transfer heat to the scrubbing solution from another process stream.

Various embodiments of the invention have been described above. However, it should be appreciated that alternative embodiments are possible and that the invention is not limited to the specific embodiments described above. For example, the gas stream comprising the targeted gas phase chemical compound may be any gas stream. In those embodiments in which the targeted gas phase chemical compound is ammonia, any gas stream comprising ammonia can be used, including any gas stream comprising ammonia and water vapor. It should also be appreciated that more than one targeted compound may be removed using the process of the present invention.

What is claimed is:

1. A method for producing a fertilizer from a gas stream comprising a nitrogen-based compound, comprising:
providing a liquid solution comprising oligomers of an organic acid;
degrading at least a portion of the oligomers in the solution into monomers of the acid to generate a solution comprising the monomers of the acid;
adding the solution comprising monomers of the acid to a scrubbing solution;
contacting the scrubbing solution with a gas stream comprising a gaseous nitrogen-based compound;
absorbing the nitrogen-based compound into the scrubbing solution;
producing a disassociated form of the absorbed nitrogen-based compound based upon the compositions of the monomers of the acid and the nitrogen-based compound in the scrubbing solution; and
separating at least a portion of the scrubbing solution comprising the disassociated form of the absorbed nitrogen-based compound, thereby creating a liquid fertilizer.
